(19) United States
(12) Patent Application Publication
(10) Pub. No.: US 2023/0387626 A1
(43) Pub. Date: Nov. 30, 2023

(54) CONNECTOR

(71) Applicant: SUMITOMO WIRING SYSTEMS, LTD., Mie (JP)

(72) Inventor: Koichi YOKOTANI, Mie (JP)

(21) Appl. No.: 18/032,176

(22) PCT Filed: Oct. 26, 2021
(86) PCT No.: PCT/JP2021/039463

§ 371 Date: Apr. 16, 2023

(30) Foreign Application Priority Data
Oct. 28, 2020 (JP) 2020-180659

(51) Int. Cl. H01R 13/52; H01R 13/502; H01R 13/621

(52) U.S. Cl. CPC H01R 13/5219; H01R 13/502; H01R 13/621

(57) ABSTRACT

A connector (10) according to an aspect of the present disclosure comprises: a housing (20) having an opening (23) and a facing surface (24a) that is provided at the peripheral edge of the opening (23) and faces the outer surface of a case; a terminal (30) that is exposed from the opening (23); a plate (50) that protrudes to the outer periphery side of the opening (23) from the housing (20) and is attached to the case; and a seal member (60) provided on the facing surface (24a), and having an annular seal main body pail (61) that surrounds the peripheral edge of the opening (23) and seals a space between the housing (20) and the case. The plate (50) has a through-hole (52) that penetrates in the thickness direction of the plate (50). The seal member (60) has an extension part (62) that extends from the seal main body part (61) toward the plate (50) and is inserted into the through-hole (52), and a falling-off prevention part (65) that is provided on the extension part (62) and prevents the extension part (52) from falling off from the through-hole (52) by engaging with the plate (50).

### TECHNICAL FIELD

The present disclosure relates to a connector.

### BACKGROUND

Conventionally, a wiring harness for electrically connecting devices for vehicle is known (e.g. see Patent Document 1). A connector to be attached to the device is provided on one end of the wiring harness. This connector is provided with a housing made of resin and having an opening, a plurality of terminals integrally molded with the housing and a plate made of metal. The plate projects from the housing to an outer peripheral side of the opening. By bolt-fastening the plate to a case of the device, the connector is fixed to the case of the device.

The housing has a facing surface provided on the peripheral edge of the opening and facing the outer surface of the case. An annular sealing member for sealing between the housing and the case is provided on the facing surface. The sealing member includes a plurality of engaging portions to be engaged with a plurality of projections projecting from the facing surface. The engaging portion is provided with a through hole, into which the projection is inserted. By engaging the engaging portions with the projections, the detachment of the sealing member from the housing is suppressed.

### PRIOR ART DOCUMENT

### Patent Document

Patent Document 1: WO 2015/072335 A1

### SUMMARY OF THE INVENTION

### Problem to be Solved

In a state where such a connector is connected to the device, the sealing member is in close contact with the outer surface of the case. Thus, the sealing member may adhere to and remain on the outer surface of the case in removing the connector from the device, whereby the engaging portions may be disengaged from the projections and the sealing member may be detached from the housing. Thus, it is desired to further suppress the detachment of the sealing member from the housing.

The present disclosure aims to provide a connector capable of suppressing the detachment of a sealing member.

### Means to Solve the Problem

The present disclosure is directed to a connector to be mounted on an outer surface of a case of a device and electrically connected to the device, the connector being provided with a housing including an opening and a facing surface provided on a peripheral edge of the opening, the facing surface facing the outer surface of the case, a terminal exposed from the opening, a plate projecting from the housing to an outer peripheral side of the opening, the plate being mounted on the case, and a sealing member provided on the facing surface, the sealing member including an annular sealing body portion for surrounding the peripheral edge of the opening and sealing between the housing and the case, the plate including a through hole penetrating through the plate in a thickness direction, and the sealing member including an extending portion extending from the sealing body portion toward the plate, the extending portion being inserted into the through hole, and a retaining portion provided on the extending portion, the retaining portion preventing the extending portion from coming out from the through hole by being engaged with the plate.

### Effect of the Invention

According to the present disclosure, it is possible to suppress the detachment of a sealing member.

### BRIEF DESCRIPTION OF THE DRAWINGS

FIG. 1 is a plan view of a connector of one embodiment.

FIG. 2 is a section along 2-2 of FIG. 1.

FIG. 3 is a perspective view of the connector of the embodiment.

FIG. 4 is a section along 4-4 of FIG. 1.

### DETAILED DESCRIPTION TO EXECUTE THE INVENTION

### Description of Embodiments of Present Disclosure

First, embodiments of the present disclosure are listed and described.

[1] The connector of the present disclosure is a connector to be mounted on an outer surface of a case of a device and electrically connected to the device, and is provided with a housing including an opening and a facing surface provided on a peripheral edge of the opening, the facing surface facing the outer surface of the case, a terminal exposed from the opening, a plate projecting from the housing to an outer peripheral side of the opening, the plate being mounted on the case, and a sealing member provided on the facing surface, the sealing member including an annular sealing body portion for surrounding the peripheral edge of the opening and sealing between the housing and the case, the plate including a through hole penetrating through the plate in a thickness direction, and the sealing member including an extending portion extending from the sealing body portion toward the plate, the extending portion being inserted into the through hole, and a retaining portion provided on the extending portion, the retaining portion preventing the extending portion from coming out from the through hole by being engaged with the plate.

According to this configuration, the extending portion of the sealing member is inserted into the through hole and the retaining portion provided on the extending portion is engaged with the plate. Thus, the extending portion is prevented from coming out from the through hole. Therefore, the detachment of the sealing member from the housing can be suppressed.

[2] Preferably, a plurality of the terminals are arranged in parallel.

In the connector in which the plurality of terminals are arranged in parallel, dimensions of the opening increase according to the number of the terminals. As the dimensions of the opening increase, a contact area of the sealing member and the outer surface of the case increases and the sealing member easily adheres to the outer surface of the case. As a result, the sealing member is easily detached from the housing.

In this respect, the extending portion is prevented from coming out from the through hole as described above in the above configuration, whereby the detachment of the sealing member from the housing can be suppressed.

[3] Preferably, the sealing body portion has a sealing surface configured to contact the outer surface of the case, and the sealing surface is provided at a position more distant from the facing surface than the extending portion in a direction orthogonal to the facing surface.

According to this configuration, when the sealing surface contacts the outer surface of the case, the extending portion hardly contacts the outer surface of the case. Thus, the extending portion hardly adheres to the outer surface of the case. In this way, in removing the connector from the case, the extending portion is suppressed from coming out from the through hole while adhering to the case. Therefore, the detachment of the sealing member from the housing can be further suppressed.

[4] Preferably, the terminal includes an insertion hole, a bolt used for connection to a mating terminal provided in the device being inserted into the insertion hole, the opening penetrates through the housing, and the entire insertion hole overlaps the opening when viewed from a penetration direction of the opening.

According to this configuration, a tool for tightening the bolt can be inserted through the opening penetrating through the housing. Therefore, the terminal and the mating terminal can be easily connected.

### Details of Embodiment of Present Disclosure

A specific example of a connector of the present disclosure is described below with reference to the drawings. Some of components may be shown in an exaggerated or simplified manner for the convenience of description in each drawing. Further, a dimension ratio of each part may be different in each drawing. Note that the present disclosure is not limited to these illustrations, but is represented by claims and intended to include all changes in the scope of claims and in the meaning and scope of equivalents. “Orthogonal” in this specification means not only strictly orthogonal, but also substantially orthogonal within a range in which functions and effects in this embodiment are achieved.

(Configuration of Connector 10)

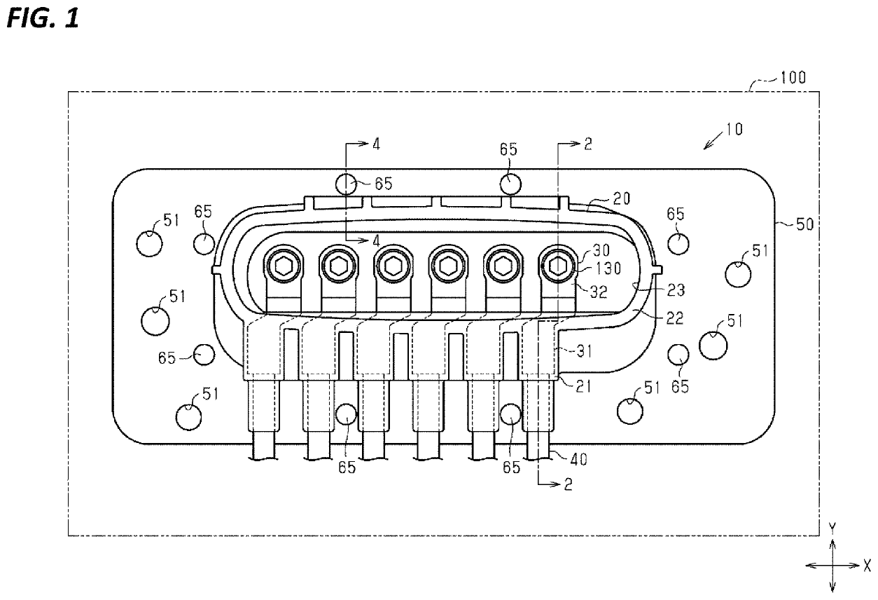

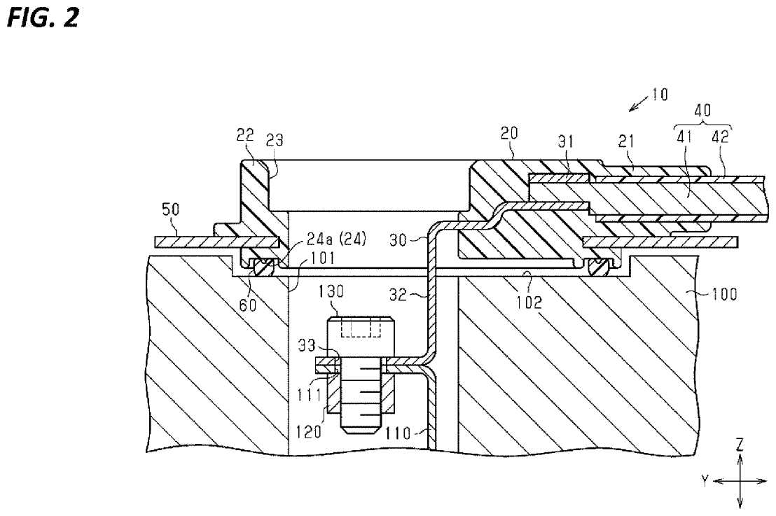

As shown in FIGS. 1 and 2, a connector 10 is, for example, electrically connected to a device for vehicle such as a motor or inverter. The connector 10 is mounted on an outer surface 102 of a case 100 of the device having an opening 101.

The connector 10 is provided with a housing 20, a plurality of terminals 30 held in parallel in the housing 20, a plate 50 integrally provided in the housing 20 and a sealing member 60 for sealing between the housing 20 and the case 100. The connector 10 is, for example, provided with six terminals 30. Wires 40 are electrically connected to the terminals 30. The wires 40 are pulled out from the housing 20.

Hereinafter, an arrangement direction of the plurality of terminals 30 is referred to as an X-axis direction, an extending direction of the wires 40 pulled out from the housing 20 is referred to as a Y-axis direction and a direction orthogonal to both the X-axis direction and the Y-axis direction is referred to as a Z-axis direction. The X-axis direction, Y-axis direction and Z-axis direction are orthogonal to each other.

(Configuration of Housing 20)

The housing 20 includes a holding portion 21 for holding the plurality of terminals 30 and a tubular portion 22 having a tubular shape. The housing 20 is formed of a resin material such as polybutylene terephthalate (PBT).

The holding portion 21 projects from the tubular portion 22 to an outer peripheral side of the tubular portion 22. The holding portion 21 holds connected parts of the terminals 30 and the wires 40. The plurality of terminals 30 connected to the wires 40 and the housing 20 are integrated by insert molding.

The tubular portion 22 includes an opening 23 penetrating in the Z-axis direction. That is, a penetration direction of the opening 23 and the Z-axis direction coincide. The opening 23 has an oval shape long in the X-axis direction.

Although not shown, a service cover made of resin is provided on the opening 23 of the housing 20. Further, the housing 20 is provided with a shield shell made of metal and configured to cover the service cover and be fixed to the plate 50.

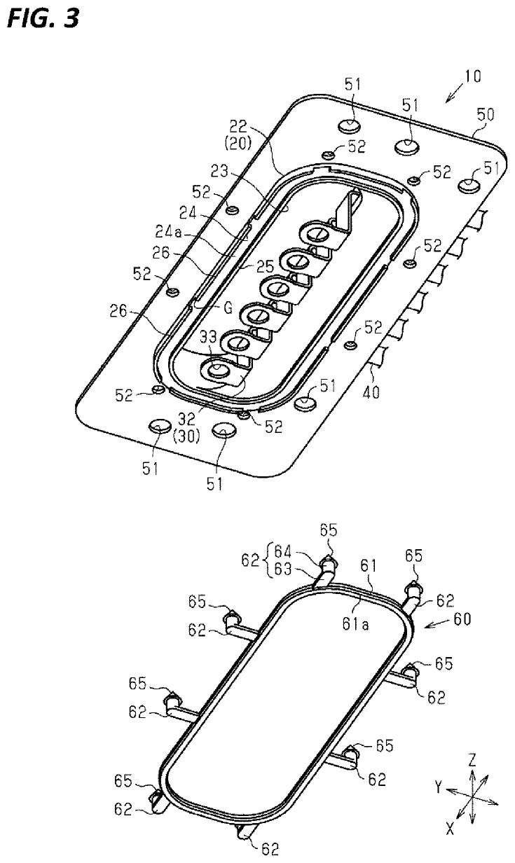

As shown in FIG. 3, a groove 24 facing the outer surface 102 of the case 100 is provided in the peripheral edge of the opening 23 in the tubular portion 22. The groove 24 is recessed toward a side opposite to the case 100 in the Z-axis direction.

The groove 24 has an annular shape surrounding the opening 23. A facing surface 24a facing the outer surface 102 of the case 100 is provided in a bottom part of the groove 24. The facing surface 24a is orthogonal to the Z-axis direction. The facing surface 24a is provided at a position closer to the case 100 than the plate 50 in the Z-axis direction.

The groove 24 includes an inner wall 25 rising from the inner edge of the annular facing surface 24a and a plurality of outer walls 26 rising from the outer edge of the facing surface 24a. The inner wall 25 and the outer walls 26 are facing each other.

The inner wall 25 is provided around the entire opening 23 in a circumferential direction. The plurality of outer walls 26 are provided at intervals in the circumferential direction of the opening 23. That is, a gap G is provided between two outer walls 26 adjacent in the circumferential direction of the opening 23. The housing 20 is, for example, provided with eight gaps G.

(Configuration of Terminal 30)

As shown in FIG. 2, the terminal 30 includes a wire connecting portion 31 and a terminal connecting portion 32. The terminal 30 is a single component in which the wire connecting portion 31 and the terminal connecting portion 32 are integrally formed. The terminal 30 is, for example, made of a metal material such as copper, copper alloy, aluminum, aluminum alloy or stainless steel.

The wire 40 is electrically connected to the wire connecting portion 31. Here, the wire 40 includes a core wire 41 and an insulation coating 42 covering the outer periphery of the core wire 41. The core wire 41 is exposed from the insulation coating 42 at an end part of the wire 40. The core wire 41 exposed from the insulation coating 42 is connected to the wire connecting portion 31.

The wire connecting portion 31 and a part connected to the wire connecting portion 31, out of the wire 40, are held in the holding portion 21 and the housing 20. The wire connecting portion 31 extends toward the opening 23 in the Y-axis direction as a whole. As shown in FIG. 1, an intermediate part of the wire connecting portion 31 in a length direction extends toward the opening 23 while being bent in a direction intersecting both the X-axis direction and the Y-axis direction.

As shown in FIG. 2, the terminal connecting portion 32 is, for example, plate-like. The terminal connecting portion 32 includes a base end part projecting into the opening 23 from the wire connecting portion 31, an intermediate part bent from the base end part and extending toward the opening 101 of the case 100 in the Z-axis direction and a tip part bent from the intermediate part and extending opposite to the holding portion 21 in the Y-axis direction. The terminal connecting portion 32 is exposed from the opening 23 of the housing 20. In this embodiment, a part of the intermediate part of the terminal connecting portion 32 projects in the Z-axis direction from the opening 23. Thus, the tip part of the terminal connecting portion 32 is located outside the opening 23 and inside the opening 101 of the case 100.

The tip part of the terminal connecting portion 32 is provided with an insertion hole 33 penetrating through the terminal connecting portion 32 in the Z-axis direction. That is, an axis of the insertion hole 33 coincides with the penetration direction of the opening 23. When viewed from the Z-axis direction, the entire insertion hole 33 overlaps the opening 23.

The terminal 30 is electrically connected to a mating terminal 110 made of metal and provided inside the opening 101 of the case 100. The mating terminal 110 includes a through hole 111 penetrating in the Z-axis direction. A nut 120 communicating with the through hole 111 is, for example, mounted on the mating terminal 110. A bolt 130 inserted into the insertion hole 33 of the terminal 30 and the through hole 111 of the mating terminal 110 is screwed into the nut 120, whereby the terminal 30 and the mating terminal 110 are fastened. Note that, although not shown, a tool for tightening the bolt 130 is inserted through the opening 23 of the housing 20 in the Z-axis direction.

(Configuration of Plate 50)

As shown in FIG. 1, the plate 50 is long in the X-axis direction and, for example, formed of an iron-based metal material. The plate 50 and the housing 20 are integrated by insert molding. The plate 50 includes a plurality of mounting holes 51 penetrating in a thickness direction of the plate 50, i.e. the Z-axis direction. The plate is, for example, provided with six mounting holes 51. The mounting hole 51 has, for example, a circular cross-sectional shape. An unillustrated bolt for mounting the plate on the case 100 is inserted through the mounting hole 51. By mounting the plate 50 on the case 100, the connector 10 is mounted on the outer surface 102 of the case 100.

As shown in FIG. 3, the plate 50 includes a plurality of through holes 52 penetrating in the thickness direction of the plate 50, i.e. the Z-axis direction. The plate 50 is, for example, provided with eight through holes 52. The through hole 52 has, for example, a circular cross-sectional shape. A diameter of the through hole 52 is smaller than that of the mounting hole 51. Each through hole 52 is provided near the gap G between the outer walls 26 in the plate 50.

(Configuration of Sealing member 60)

As shown in FIG. 2, the sealing member 60 is fit in the groove 24. Accordingly, the sealing member 60 is provided on the facing surface 24a. The sealing member 60 is, for example, formed of a resilient material such as rubber.

As shown in FIG. 3, the sealing member 60 includes a sealing body portion 61, a plurality of extending portions 62 and a plurality of retaining portions 65.

The sealing body portion 61 has an annular shape surrounding the peripheral edge of the opening 23. By sandwiching the sealing body portion 61 between the facing surface 24a of the housing 20 and the outer surface 102 of the case 100, sealing is provided between the housing 20 and the case 100. The sealing body portion 61 has a sealing surface 61a configured to contact the outer surface 102 of the case 100.

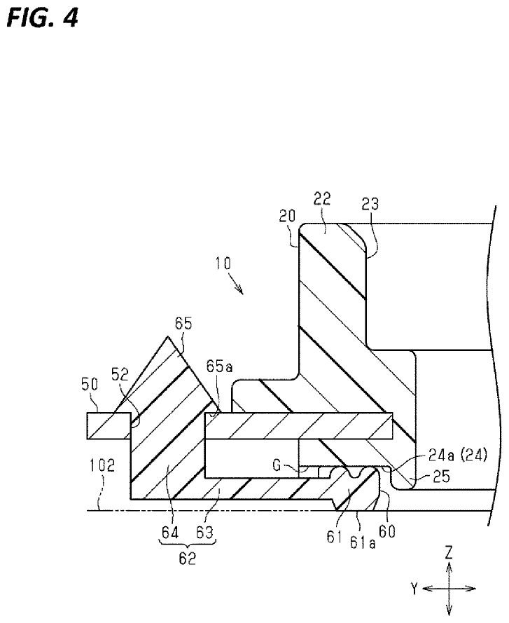

As shown in FIG. 4, the extending portion 62 includes a first extending portion 63 extending from the sealing body portion 61 to an outer peripheral side and a second extending portion 64 bent from the first extending portion 63 and extending toward the plate 50 in the Z-axis direction. The first extending portion 63 projects from the gap G between the outer walls 26. The second extending portion 64 is inserted into the through hole 52 of the plate 50. A cross-sectional shape of the first extending portion 63 orthogonal to a length direction of the first extending portion 63 is, for example, a rectangular shape. A cross-sectional shape of the second extending portion 64 orthogonal to a length direction of the second extending portion 64 is, for example, a circular shape.

The sealing surface 61a of the sealing body portion 61 described above is provided at a position more distant from the facing surface 24a than the first extending portion 63 in a direction orthogonal to the facing surface 24a, i.e. the Z-axis direction. In other words, the sealing body portion 61 projects to a position more distant from the facing surface 24a than the first extending portion 63 in the Z-axis direction. Thus, a height of the sealing body portion 61 from the facing surface 24a is larger than that of the first extending portion 63 from the facing surface 24a.

As shown in FIG. 4, the retaining portion 65 is provided on a tip part of the second extending portion 64. The retaining portion 65 has a conical shape. A diameter of a bottom surface 65a of the retaining portion 65 is larger than that of the through hole 52. The retaining portion 65 is configured to be insertable into the through hole 52 by being resiliently deformed. By the engagement of the retaining portion 65 with the plate 50, the second extending portion 64 is prevented from coming out from the through hole 52.

Functions of this embodiment are described.

The second extending portions 64 of the sealing member 60 are inserted into the through holes 52 of the plate 50. Then, the retaining portions 65 provided on the second extending portions 64 are engaged with the plate 50. Thus, the second extending portions 64 are prevented from coming out from the through holes 52.

Effects of this embodiment are described.

(1) The connector 10 is mounted on the outer surface 102 of the case 100 of the device and electrically connected to the device. The connector 10 is provided with the housing 20 including the opening 23 and the facing surface 24a, the terminals 30 exposed from the opening 23, the plate 50 projecting from the housing 20 to the outer peripheral side of the opening 23, and the sealing member 60 provided on the facing surface 24a and configured to seal between the housing 20 and the case 100. The plate includes the through holes 52 penetrating through the plate 50 in the thickness direction. The sealing member 60 includes the extending portions 62 extending from the sealing body portion 61 toward the plate 50 and to be inserted into the through holes 52 and the retaining portions 65 provided in the extending portions 62 and configured to prevent the extending portions 62 from coming out from the through holes 52 by being engaged with the plate 50.

According to this configuration, the detachment of the sealing member 60 from the housing 20 can be suppressed since the aforementioned functions are achieved.

(2) The plurality of terminals 30 of the connector 10 are arranged in parallel.

In the connector provided with the plurality of terminals 30 arranged in parallel, dimensions of the opening 23 increase according to the number of the terminals 30. As the dimensions of the opening 23 increase, a contact area of the sealing member 60 and the outer surface 102 of the case 100 increases and the sealing member 60 more easily adheres to the outer surface 102 of the case 100. As a result, the detachment of the sealing member 60 from the housing 20 easily occurs.

In this respect, the extending portions 62 are prevented from coming out from the through holes 52 as described above in the above configuration, whereby the detachment of the sealing member 60 from the housing 20 can be suppressed.

(3) The sealing body portion 61 has the sealing surface 61a configured to contact the outer surface 102 of the case 100. The sealing surface 61a is provided at a position more distant from the facing surface 24a than the first extending portions 63 in the Z-axis direction.

According to this configuration, when the sealing surface 61a contacts the outer surface 102 of the case 100, the first extending portions 63 hardly contact the outer surface 102 of the case 100. Thus, the first extending portions 63 hardly adhere to the outer surface 102 of the case 100. In this way, the first extending portions 63 are suppressed from coming out from the through holes 52 while adhering to the case 100 in removing the connector 10 from the case 100. Therefore, the detachment of the sealing member 60 from the housing 20 can be suppressed.

(4) The terminal 30 includes the insertion hole 33, into which the bolt 130 used for connection to the mating terminal 110 provided in the device is inserted. When viewed from the Z-axis direction, the entire insertion hole 33 overlaps the opening 23.

According to this configuration, the tool for tightening the bolt 130 can be inserted through the opening 23 penetrating through the housing 20. Therefore, the terminal 30 and the mating terminal 110 can be easily connected.

### Modifications

This embodiment can be modified and carried out as follows. This embodiment and the following modifications can be carried out in combination without technically contradicting each other.

Although the housing 20 of the above embodiment includes the opening 23 penetrating through the housing 20 in the Z-axis direction, the housing 20 may include the opening 23 open only on one side in the Z-axis direction. In this case, for example, a pin-shaped male terminal can be adopted as the terminal 30 and a female terminal, into which the male terminal is inserted, can be adopted as the mating terminal 110.

The sealing surface 61a of the sealing body portion 61 may be flush with the first extending portions 63. That is, a height of the sealing body portion 61 from the facing surface 24a and that of the first extending portions 63 from the facing surface 24a may be equal.

The number of the terminals 30 can be changed as appropriate. For example, the connector 10 may include one terminal 30.

The numbers of the extending portions 62 and the retaining portions 65 can be changed as appropriate.

In a connector of a reference example including a sealing member of the reference example, which does not include the retaining portions 65 and can be, for example, an O-ring, it is difficult to see the sealing body portion 61 from the outside of the connector with the connector fixed to the outer surface of the case of the device. Thus, in the connector of the reference example, it is difficult to visually judge whether or not the sealing body portion 61 is correctly arranged at a predetermined sealing position between the housing and the outer surface of the case of the device by seeing the sealing body portion 61. On the other hand, in the case of the connector 10 of the embodiment including the sealing member 60 with the retaining portions 65, with the connector 10 fixed to the outer surface 102 of the case 100 of the device as shown in FIGS. 1 and 4, it is difficult to see the sealing body portion 61 from the outside of the connector 10 since the sealing body portion 61 is arranged below the plate 50, whereas the retaining portions 65 are projecting upward from the connector 10 and can be seen from the outside of the connector 10. According to this configuration, a worker can visually judge whether or not the sealing body portion 61 is correctly arranged at a predetermined sealing position between the connector 10 and the outer surface 102 of the case 100 by seeing the projecting retaining portions 65 from the outside of the connector 10 during an operation of fixing the connector 10 to the case 100 or during inspection thereafter.

In the embodiment, the sealing body portion 61 may be compressed in the Z-axis direction. The Z-axis direction may be referred to as a compression direction of the sealing body portion 61. As shown in FIGS. 2 and 4, the sealing body portion 61 may be arranged to overlap at least a part of the plate 50 in the compression direction of the sealing body portion 61. For example, the groove 24 and/or the facing surface 24a of the housing 20 may be arranged to overlap at least a part of the plate 50 in the compression direction of the sealing body portion 61. According to this configuration, the plate 50 reinforces the housing 20 and the deflection of the housing 20 caused by a compressive reaction force of the sealing body portion 61 is reduced. Therefore, this configuration is advantageous in stabilizing the sealing performance of the sealing body portion 61.

### LIST OF REFERENCE NUMERALS

G gap
10 connector
20 housing
21 holding portion
22 tubular portion
23 opening
24 groove
24a facing surface
25 inner wall
26 outer wall
30 terminal
31 wire connecting portion
32 terminal connecting portion
33 insertion hole
40 wire
41 core wire
42 insulation coating
50 plate
51 mounting hole
52 through hole
60 sealing member
61 sealing body portion
61a sealing surface
62 extending portion
63 first extending portion
64 second extending portion
65 retaining portion
65a bottom surface
100 case
101 opening
102 outer surface
110 mating terminal
111 through hole
120 nut
130 bolt

What is claimed is:

1. A connector to be mounted on an outer surface of a case of a device and electrically connected to the device, comprising:
a housing including an opening and a facing surface provided on a peripheral edge of the opening, the facing surface facing the outer surface of the case;
a terminal exposed from the opening;
a metal plate projecting from the housing to an outer peripheral side of the opening, the metal plate being mounted on the case; and
a sealing member provided on the facing surface of the housing, the sealing member including an annular sealing body portion for surrounding the peripheral edge of the opening and sealing between the facing surface of the housing and the outer surface of the case by being sandwiched between the facing surface of the housing and the outer surface of the case,
the metal plate including a through hole penetrating through the metal plate in a thickness direction, and
the sealing member including an extending portion extending from the sealing body portion to an outer peripheral side and toward the metal plate, the extending portion being inserted into the through hole, and a retaining portion provided on the extending portion, the retaining portion preventing the extending portion from coming out from the through hole by being engaged with the metal plate.

2. The connector of claim 1, wherein a plurality of the terminals are arranged in parallel.

3. The connector of claim 1 or 2, wherein:
the sealing body portion has a sealing surface configured to contact the outer surface of the case, and
the sealing surface is provided at a position more distant from the facing surface than the extending portion in a direction orthogonal to the facing surface.

4. The connector of any one of claims 1 to 3, wherein:
the terminal includes an insertion hole, a bolt used for connection to a mating terminal provided in the device being inserted into the insertion hole,
the opening penetrates through the housing, and
the entire insertion hole overlaps the opening when viewed from a penetration direction of the opening.

5. The connector of any one of claims 1 to 4, wherein the retaining portion projects from the metal plate.

6. The connector of any one of claims 1 to 5, wherein the sealing body portion is arranged to at least partially overlap the metal plate in a compression direction of the sealing body portion.

7. The connector of any one of claims 1 to 6, wherein:
the metal plate includes a radially inner part embedded in the housing and a radially outer part projecting from the housing to the outer peripheral side and not covered by the housing,
the through hole of the metal plate is provided in the radially outer part of the metal plate, and
the sealing member includes a first extending portion extending from the sealing body portion to the outer peripheral side and a second extending portion bent with respect to the first extending portion and extending to pass through the through hole in the radially outer part of the metal plate in the thickness direction of the metal plate, and the retaining portion is provided on a tip of the second extending portion passed through the through hole.

8. The connector of any one of claims 1 to 7, wherein the sealing body portion is compressed in the thickness direction of the metal plate between the facing surface of the housing and the outer surface of the case of the device.
